(19) United States
(12) Patent Application Publication
(10) Pub. No.: US 2021/0087846 A1
(43) Pub. Date: Mar. 25, 2021

(54) PORTABLE VOCAL RECORDING BOOTH

(71) Applicant: WASSERMAN PRODUCTIONS, INC., Calabasas, CA (US)

(72) Inventors: Rick Wasserman, Culver City, CA (US); George Whittam, Santa Monica, CA (US)

(21) Appl. No.: 17/024,570

(22) Filed: Sep. 17, 2020

Related U.S. Application Data
(60) Provisional application No. 62/902,838, filed on Sep. 19, 2019.

(51) Int. Cl. E04H 15/48; E04H 15/10; E04H 15/54; H04R 1/08; G10K 11/162

(52) U.S. Cl. CPC E04H 15/48; E04H 15/10; G10K 11/162; H04R 1/08; E04H 15/54

(57) ABSTRACT

Systems, devices, and methods for a portable voice recording apparatus comprising: a frame, where the frame comprises: a top triangular frame; a bottom triangular frame; and one or more support legs connecting the top triangular frame to the bottom triangular frame; an acoustic paneling attached to the frame, where the acoustic paneling encloses at least a portion of the frame, where the acoustic paneling provides an interior of the apparatus, and where the interior of the apparatus reduces noise and echo as compared to an exterior of the apparatus.

### CROSS-REFERENCE TO RELATED APPLICATIONS

This application claims priority to and the benefit of U.S. Provisional Patent Application No. 62/902,838, filed Sep. 19, 2020, the contents of which are hereby incorporated by reference herein for all purposes.

### TECHNICAL FIELD

Embodiments relate generally to voice recording environments, and more particularly to a portable voice recording booth.

### BACKGROUND

Audio recording requires reducing or eliminated unwanted noises such as people talking, car noise, air conditioning sounds, and the like. Dedicated sound studios are found in fixed locations with extensive sound treatments to eliminate these unwanted noises. These controlled environments can allow for the recording of sound with only minimal background noise so that the recorded sound can be used for voice-over, sound effects, or the like. Recording audio outside of these controlled environments can introduce unwanted sounds. Attempting to reduce noise when recording audio outside of these controlled environments may require a performer to limit their movements in order to avoid unwanted sounds, which may negatively impact the quality of the audio performance of the performer.

### SUMMARY

A portable voice recording apparatus may include: a frame, where the frame comprises: a top triangular frame; a bottom triangular frame; and one or more support legs connecting the top triangular frame to the bottom triangular frame; an acoustic paneling attached to the frame, where the acoustic paneling encloses at least a portion of the frame, where the acoustic paneling provides an interior of the apparatus, and where the interior of the apparatus reduces noise and echo as compared to an exterior of the apparatus.

In additional apparatus embodiments, the frame may be collapsible. In additional apparatus embodiments, the frame further comprises: one or more support straps. In additional apparatus embodiments, each support strap of the one or more support straps may be attached to the frame between an upper corner of the top triangular frame and a lower opposite corner of the bottom triangular frame.

In additional apparatus embodiments, two of the one or more support straps form an X-shape. In additional apparatus embodiments, the one or more support straps may be disposed on two sides of the apparatus, where the apparatus has three sides. In additional apparatus embodiments, each support strap comprises an upper strap and a lower strap. In additional apparatus embodiments, the upper strap may be detachably attached to the lower support strap by a connector. In additional apparatus embodiments, the connector may be a side-release buckle.

Additional apparatus embodiments may include: a cap, where the cap covers the top triangular frame. In additional apparatus embodiments, the cap comprises a quilted cotton pad. In additional apparatus embodiments, the acoustic paneling comprises quilted cotton pads.

Additional apparatus embodiments may include: one or more internal elastics, where the one or more internal elastics may be disposed in at least one of: the top triangular frame, the bottom triangular frame, and the one or more support legs. In additional apparatus embodiments, the one or more internal elastics may be disposed in the top triangular frame, the bottom triangular frame, and the one or more support legs, and where each of the one or more internal elastics connect the frame when the frame may be disassembled. In additional apparatus embodiments, the one or more internal elastic comprise a bungee cord. In additional apparatus embodiments, the one or more support legs comprise three legs, and where one of the three support legs comprises a utility pole. In additional apparatus embodiments, the utility pole comprises one or more mounts and a power hub. Additional apparatus embodiments may further include: a light bar disposed proximate the top triangular frame, where the light bar may be connected to the power hub by a light bar power cable; a dimmer knob connected to the light bar power cable, where the dimmer knob may be configured to adjust a light output of the light bar; one or more microphones attached to one or more mounts; and one or more trays attached to the one or more mounts.

A method embodiment may include: connecting one or more first poles via one or more external couplings to form a first support leg of three support legs; connecting one or more first poles via one or more external couplings to form a second support leg of three support legs; connecting one or more first poles via one or more external couplings to form a third support leg of three support legs, where the third support leg comprises a utility pole, and where the utility pole comprises one or more mounts and a power hub; connecting one or more second poles via one or more external couplings and one or more three-way angled couplings to form a top triangular frame; connecting one or more second poles via one or more external couplings and one or more three-way angled couplings to form a bottom triangular frame; connecting each of the three support legs to the top triangular frame and the bottom triangular frame via the one or more three-way angled couplings, where the three support legs, the top triangular frame, and the bottom triangular frame form a frame; connecting one or more support straps between an upper corner of the top triangular frame and a lower opposite corner of the bottom triangular frame, where two of the one or more support straps form an X-shape, and where the one or more support straps may be disposed on two sides of the frame, where the frame has three sides; and connecting an acoustic paneling to the frame, where the acoustic paneling encloses at least a portion of the frame, where the acoustic paneling provides an interior of the apparatus, and where the interior of the apparatus reduces noise and echo as compared to an exterior of the apparatus.

Additional method embodiments may include: detaching the acoustic paneling from the frame; detaching the one or more support straps from the frame; disconnecting each of the three support legs from the top triangular frame and the bottom triangular frame; disconnecting the one or more second poles of the bottom triangular frame; disconnecting the one or more second poles of the top triangular frame; disconnecting the one or more first poles from each of the three support legs; and storing the disconnected top triangular frame, bottom triangular frame, three support legs and acoustic paneling in a case for storage and transport.

Another portable voice recording apparatus may include: a frame, where the frame may include: a top triangular frame; a bottom triangular frame; one or more support legs connecting the top triangular frame to the bottom triangular frame, where the one or more support legs comprise three legs, and where one of the three support legs comprises a utility pole, where the Utility Pole comprises one or more mounts and a power hub; one or more support straps, where each support strap of the one or more support straps is attached to the frame between an upper corner of the top triangular frame and a lower opposite corner of the bottom triangular frame, where two of the one or more support straps form an X-shape, where each support strap comprises an upper strap and a lower strap, and where the upper strap is detachably attached to the lower support strap by a connector; an acoustic paneling attached to the frame, wherein the acoustic paneling encloses at least a portion of the frame; a cap, where the cap covers the top triangular frame; one or more internal elastics, where the one or more internal elastics are disposed in at least one of: the top triangular frame, the bottom triangular frame, and the one or more support legs, and where each of the one or more internal elastics connect the frame when the frame is disassembled; a light bar disposed proximate the top triangular frame, where the light bar is connected to the power hub by a light bar power cable; a dimmer knob connected to the light bar power cable, where the dimmer knob is configured to adjust a light output of the light bar; one or more microphones attached to one or more mounts; and one or more trays attached to the one or more mounts; where the frame is collapsible.

An apparatus for voice recording may include: a collapsible structure; a first wall of sound-absorbing material coupled to the collapsible structure; a second wall of sound-absorbing material angled less than ninety degrees relative to the first wall of sound-absorbing material and coupled to the collapsible structure; and a microphone support disposed between the first and second walls of sound-absorbing material and coupled to the collapsible structure.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a portable voice recording apparatus, according to one embodiment;

FIG. 2 depicts a frame of a portable voice recording apparatus, according to one embodiment;

FIG. 3 depicts a frame of the portable voice recording apparatus of FIG. 2, according to one embodiment;

FIG. 4 depicts an elastic system within the frame of FIG. 2, according to one embodiment;

FIG. 5 depicts support straps of the frame of FIG. 2, according to one embodiment;

FIG. 6 depicts skirts enclosing the frame of FIG. 4, according to one embodiment;

FIG. 7 depicts a cap on top of the frame of FIG. 3, according to one embodiment;

FIG. 8 depicts accessories associates with the portable voice recording apparatus of FIG. 2, according to one embodiment;

FIG. 9 depicts a top frame portion of the portable voice recording apparatus of FIG. 1, according to one embodiment;

FIG. 10 depicts a case for transporting the portable voice recording apparatus of FIG. 1, according to one embodiment;

FIG. 11A is a perspective view of an embodiment of a portable vocal recording booth frame, according to one embodiment;

FIG. 11B is a front elevational view of the embodiment of FIG. 11A;

FIG. 11C is a rear elevational view of the embodiment of FIG. 11A;

FIG. 11D is a right side elevational view of the embodiment of FIG. 11A;

FIG. 11E is a left side elevational view of the embodiment of FIG. 11A;

FIG. 11F is top plan view of the embodiment of FIG. 11A;

FIG. 11G is a bottom plan view of the embodiment of FIG. 11A;

FIG. 12A is a perspective view of the portable vocal recording booth having a cap and skirts covering the frame of FIG. 11A;

FIG. 12B is a front elevational view of the embodiment of FIG. 12A;

FIG. 12C is a rear elevational view of the embodiment of FIG. 12A;

FIG. 12D is a right side elevational view of the embodiment of FIG. 12A;

FIG. 12E is a left side elevational view of the embodiment of FIG. 12A;

FIG. 12F is top plan view of the embodiment of FIG. 12A;

FIG. 12G is a bottom plan view of the embodiment of FIG. 12A;

FIG. 13 illustrates an example top-level functional block diagram of a computing device embodiment;

FIG. 14 shows a high-level block diagram and process of a computing system for implementing an embodiment of the system and process;

FIG. 15 shows a block diagram and process of an exemplary system in which an embodiment may be implemented; and

FIG. 16 depicts a cloud computing environment for implementing an embodiment of the system and process disclosed herein.

### DETAILED DESCRIPTION

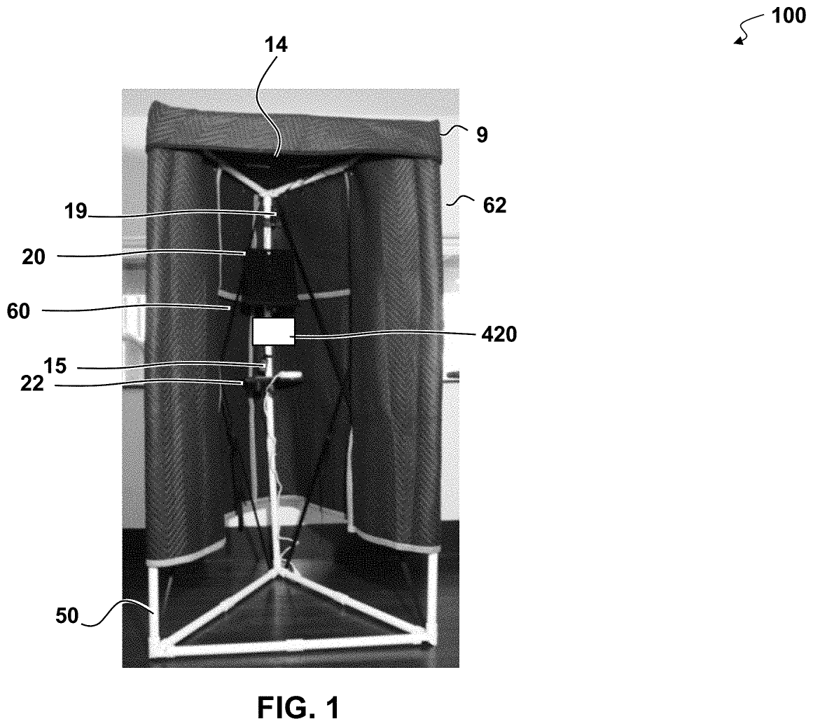

With respect to FIG. 1, a portable voice recording apparatus 100 is shown. The portable voice recording apparatus 100 may include an acoustic paneling 9 enclosing a three-sided frame 50. In some embodiments, the acoustic paneling 9 may be made from quilted cotton furniture pads with polyester binding. In other embodiment, the acoustic paneling 9 may be made from sound blankets. In other embodiments, the acoustic paneling 9 may be any thick material for absorbing and/or blocking sound. In some embodiments, the acoustic paneling 9 may enclose at least a portion of the frame 50. In other embodiments, the acoustic paneling 9 may enclose an entire top and sides of the frame, leaving a portion at the bottom open for air flow. The acoustic paneling 9 may provide an interior 60 of the apparatus 100 that reduces external noises as compared to an exterior 62 of the apparatus 100; provides an accurate and echo-free recording space in the interior 60, and/or provides for user control of the acoustical properties within the interior 60.

Configured as such, the apparatus 100 may provide a three-sided enclosed acoustic environment allowing for accurate and echo-free recording, as well as for user control of the acoustical properties within the apparatus 100. Additionally, the apparatus 100 may be collapsible, allowing for storage and travel.

The apparatus 100 may enclose a user for accurate voice recording, allowing the user to physicalize the user's performance with the user's entire body while recording. More specifically, the apparatus 100 provides a floor plan for a user to stand before a recording device, such as a microphone, while allowing enough room for the user to move the user's head, torso, arms, and hands during recording. In one embodiment, a holder 20 is attached to the frame 50. In one embodiment, the holder 20 may hold provide for holding reading materials, such as a paper reading materials, or digital reading materials on, for example, a tablet or small laptop. A power hub may include one or more AC and/or USB outlets for charging of the tablet or small laptop, as well as other electronic devices. An adjustable boom arm 19 may also be attached to the frame 50 for supporting a microphone. More specifically, the adjustable boom arm 19 may support a microphone's shock-mount. The apparatus 100 may also include a light bar 14 for illumination. In one embodiment, the light bar 14 is a dimmable LED light bar operated with a switch, and connected to a power strip 15. The apparatus 100 further includes a tray 22. The tray 22 may be an adjustable utility shelf for resting materials on, such as a beverage. Additionally, the apparatus 100 may include a computing device 420 for digital signal processing, as described in detail below.

The light 14 is shown for illumination of the apparatus 100 within the enclosure 9. The light 14 may enhance the ability generally navigate within the apparatus 100, as well as to enhance visibility around the holder 20 for reading materials on the holder 20. For example, the light 14 may help illuminate a script or other document held on the holder 20. In some embodiments, the apparatus 100 may include at least two walls comprising a damping material. The at least two walls may be angled relative to one another.

An apparatus 100 for voice recording is disclosed in one embodiment. The apparatus 100 may include: a collapsible structure, such as frame 50. The apparatus 100 may also include a first wall of sound-absorbing material coupled to the collapsible structure and a second wall of sound-absorbing material angled less than ninety degrees relative to the first wall of sound-absorbing material and coupled to the collapsible structure. The apparatus 100 may also include a microphone support disposed between the first and second walls of sound-absorbing material and coupled to the collapsible structure. In one embodiment, the wall of sound-absorbing material may include a quilted blanket. In another embodiment, the wall of sound-absorbing material may include a foam material. In other embodiments, the wall of sound-absorbing material may be any material that absorbs sounds, reduces echoes, and the like. In one embodiment, the collapsible structure may be made from PVC. In other embodiments, the collapsible structure may be made from any materials that may be disassembled and reassembled to form the disclosed apparatus for voice recording. While a triangular shape is shown for the purposes of illustration, the apparatus 100 may be a v-shape having first and second walls of sound-absorbing material with a microphone support disposed between the first and second walls in some embodiments.

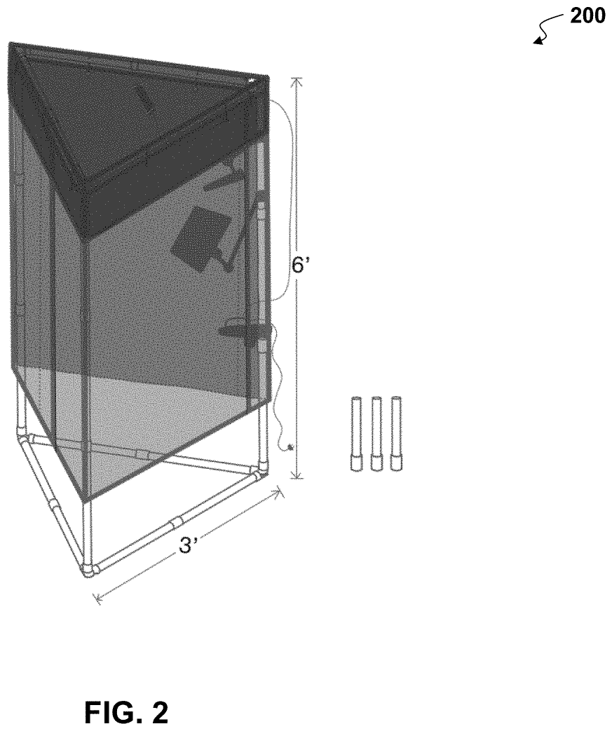

With respect to FIG. 2, an apparatus 200 is shown in a fully assembled configuration. In some embodiments, the apparatus may have a height of about 6 feet and a width of about 3 feet. Other heights and widths are possible and contemplated.

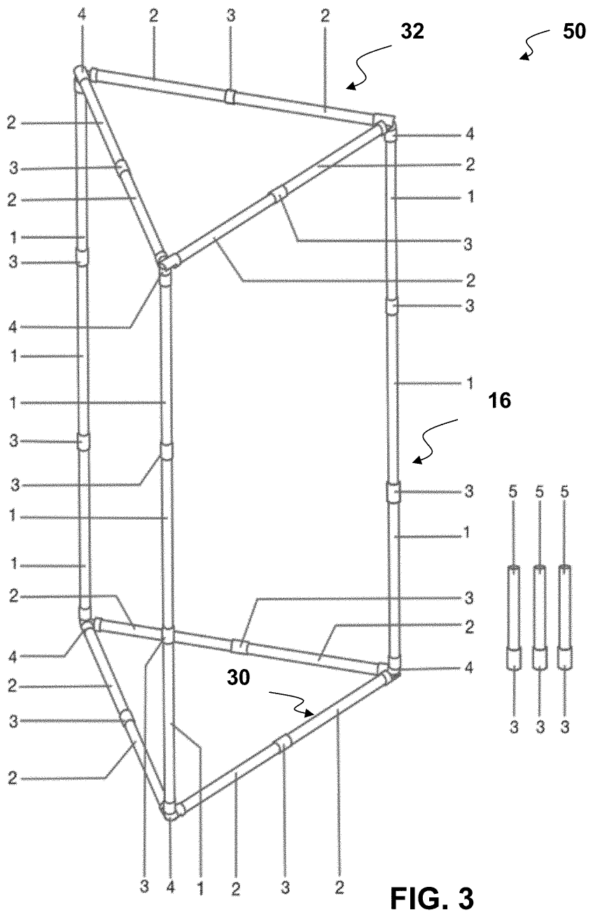

With respect to FIG. 3, a frame 50 of the portable voice recording apparatus of

FIG. 2 is shown with an isosceles triangular prism configuration. This configuration may allow a user, such as a vocal performer the space with which to gesture or physicalize the user's performance while giving the user familiarity of being inside a completely enclosed space that one would expect of an isolation booth. This configuration may further allow for the portable voice recording apparatus to be constructed with fewer pieces than, for example, a rectangular voice recording apparatus. In one embodiment, the frame 50 may have nine first poles 1 making up the apparatus' three vertical support legs 16. In one embodiment, the poles 1 may be 2 feet in length. In one embodiment, one of the three support legs 16 may be pre-installed with hardware to hold a microphone and a holder. The pre-installed support leg may be referred to as a “Utility Pole”. The Utility Pole may provide industry-standard microphone mounting, a lectern for paper or digital tablet for scripts, and/or accessories for holding items such as beverages, pencils, and the like. Also, attached to the Utility Pole may be a power hub capable of providing electricity to both USB accessories and standard 110V household power sockets.

The frame 50 may have twelve second poles 2 making up the sides of a top triangular frame 32 and a bottom triangular frame 30. In one embodiment, the poles may be 1.5 feet in length. The frame 50 may further include twelve external couplings 3 for connection of the first poles 1 and the second poles 2. In one embodiment, the external couplings 3 may be 1 inch long. The frame 50 may further include six three-way angled couplings 4 for connecting the support legs 16 to the top triangular frame 32 and the bottom triangular frame 30.

In one embodiment, pole extensions 5 may provide for the frame 50 to be extended in height. For example, the three pole extensions 5 may be one foot in length and can extend the frame 50 to a height of approximately seven feet. The three pole extensions 5 may attach to the support legs to add an additional foot of height to the portable voice recording apparatus.

In one embodiment, all pole segments 1,2 may be shorter than 2 feet allowing the portable voice recording apparatus 200 to be packed down into airline-acceptable luggage. The frame 50 may be made of lightweight materials, such as PVC allowing for the luggage to remain under 501b s in order for a traveler to not incur check-in fees at the airport for “heavy” luggage. In another embodiment, the lightweight poles 1,2 and couplings 3 may be made of carbon fiber, aluminum, or other materials.

In one embodiment, the bottom frame 30 and the top frame 32 may each be equilateral triangles each having dimensions of 3 feet×3 feet×3 feet. In another embodiment, the bottom frame 30 and the top frame 32 may be isosceles triangles. In one embodiment, the apparatus 200 stands 6 feet in height. In another embodiment, the apparatus 200 stands 6.5 feet in height. In other embodiments, the apparatus 200 may stand at heights approximately between 5 feet and 8 feet. The sides of the top frame 32 and the bottom frame 30 may range between 2 feet and 5 feet. The apparatus 200 may accommodate more than one user.

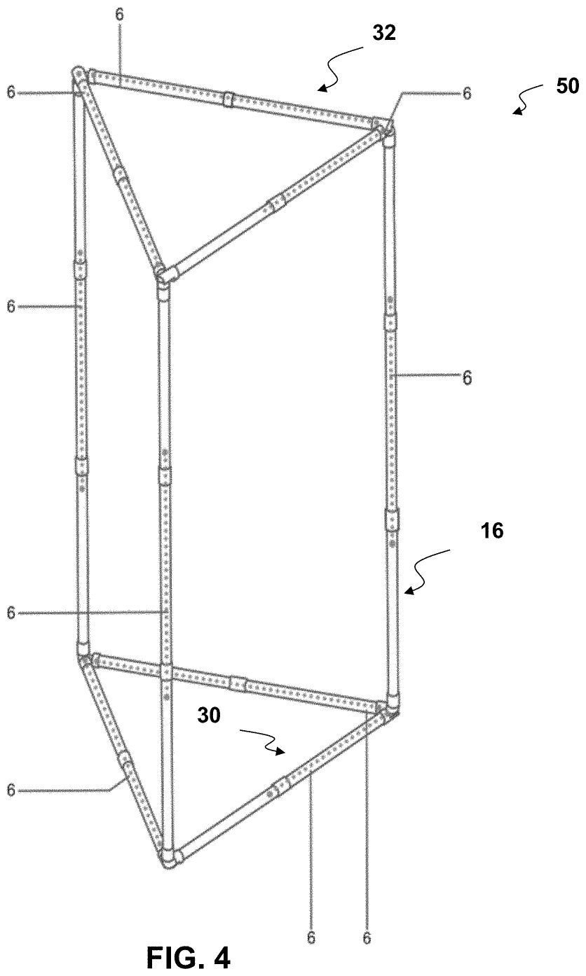

With respect to FIG. 4, the frame 50 may have internal elastic 6 used to keep the poles 1,2 and couplings 3 connected. In one embodiment, nine lengths of elastic 6 may extend through each support leg 16 and each triangular frame 30,32 so that assembly and disassembly are clearly obvious and no pieces may be lost or detachably attached together incorrectly. In one embodiment, the nine lengths of elastic 6 may be 5/16 inch shock cord or bungee. The large dots inside the frame 50 are illustrated to show the ends or terminal points of the internal elastic 6. The elastic 6 configuration means that quick assembly or disassembly may not require tools and/or instructions. In one embodiment, the frame 50 and apparatus 200 may be assembled or disassembled in less than approximately 10 minutes. While nine lengths of elastic 6 are shown and described, other numbers of elastic are possible and contemplated, such as five lengths of elastic for each of the bottom frame 30, the top frame 32, and each support leg 16.

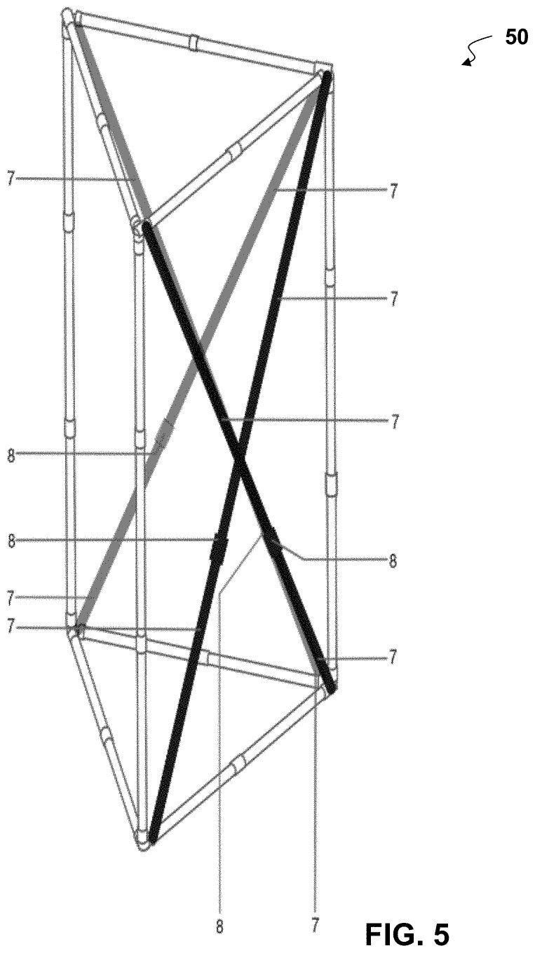

With respect to FIG. 5, support straps 7 may be attached to the frame 50 to further secure the frame 50. More specifically, 8 support straps 7 may be bolted from an upper corner to an opposite lower corner on two of the three sides of the frame 50 and may be connected to each other to form large X's. In one embodiment, the straps are 1 inch nylon seatbelt webbing. In one embodiment, the straps are 52 inches in length. Additionally, four connectors 8 allow the upper straps to connect with the lower straps. In one embodiment, the connectors 8 are plastic side-release buckles. Four upper straps 7 may have the female end of the buckle and the four lower straps 7 have the male end of the buckle. The male buckle components may also allow for adjusting how loose or tight the straps 7 are. Once the straps 7 are tightened, the straps 7 may not need to be further adjusted. The straps 7 may be long enough to accommodate the addition of the pole extensions 5 of FIG. 3. The support straps 7 provide further support for the frame 50. In one embodiment, the frame 50 has 4 support straps 7. Each support strap 7 may run diagonally on a side of the frame 50, from one joint 4 associated with the top frame 32 to a joint 4 associated with the bottom frame 30. In one embodiment, the straps 7 are made of nylon. In another embodiment, the straps are made of steel cable, Kevlar line, or paracord.

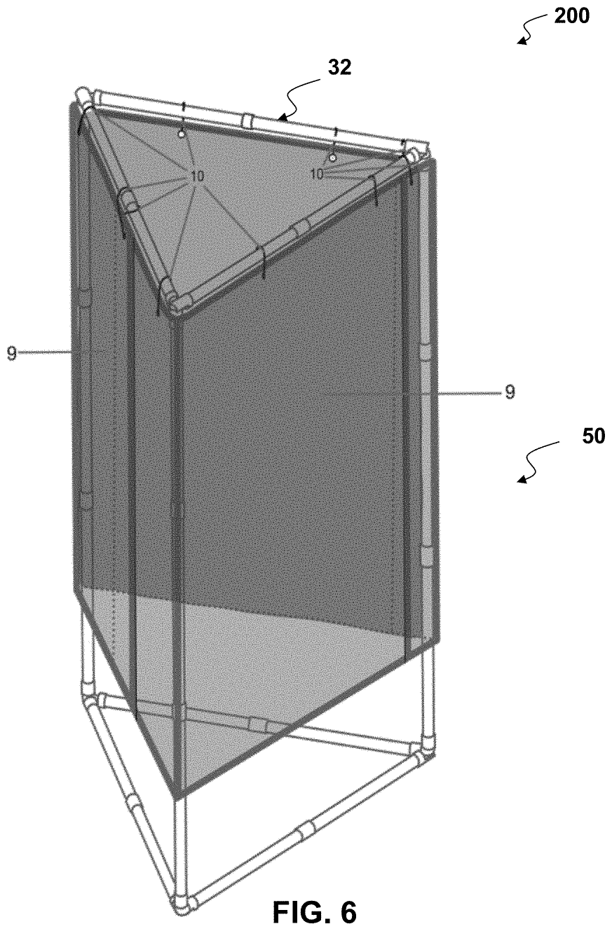

With respect to FIG. 6, three acoustic skirts 9 may surround the frame 50 of the apparatus 200. The skirts 9 may provide a desired “clean” sound environment, such as for when a performer requires recording their vocals. In one embodiment, two of the skirts 9 may be six feet in width and five feet in height. In one embodiment, the two skirts 9 are made of moving blankets quilted material. The two skirts 9 may be suspended from the top frame 32 and may enclose a user inside the apparatus 200.

The top third of the skirts 9 (where a user's head, neck, and chest may be) may be double insulated with acoustic material for a cleaner and quieter sound environment. In one embodiment, the skirts 9 do not touch the ground so that air can easily come in and out of the apparatus 200. The skirts 9 may act as doorway flaps and may be opened and folded out of the way.

In one embodiment, the skirts 9 may have one or more grommet, such as ten grommets 10 of ⅜ inch length. The grommets 10 may be installed at evenly-spaced, one inch intervals from a top seam of the skirts. In one embodiment, each skirt has 5 grommets 10 and 5 hooks. Additionally, ten roller hooks may be inserted into each grommet 10 and to keep the grommets 10 in place. In one embodiment, the hooks may be shower curtain rings with rollers to ease the side to side movement of the hooks. The skirts 9 may be hooked on the top triangle frame 32 so that the one side of the apparatus 200 without straps 7 (see FIG. 5) becomes the “door” side where a user may enter or exits the apparatus 200. The hooks may allow for extremely fast and easy attachment of the skirts 9.

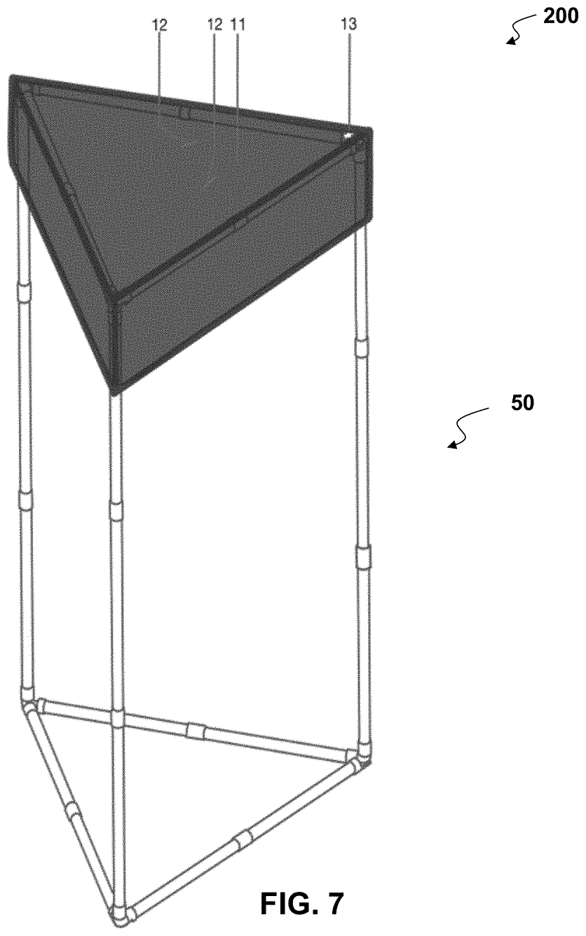

With respect to FIG. 7, a cap 11 covers the top frame 32. If a user needs to ventilate or relieve any feeling of claustrophobia, the cap 11 may be opened partially or removed entirely. In one embodiment, the cap 11 is made of moving blankets, quilted material, and/or acoustic materials for absorbing sound. The cap 11 may be double insulated to ensure a cleaner and quieter sound environment of the apparatus 200. The cap 11 may be lifted up on one corner to adjust the heat inside the apparatus 200 for optimal comfort. Two elastic members 12 may be attached on the underside of the cap 11 to hold a light bar 14 (see FIG. 1). The elastic members 12 may be 1 inch in length in some embodiments. The elastic members may be white in color in some embodiments. Furthermore, a one inch white star may be painted on the underside of the cap 11 as a visual indicator. Other visual indicators are possible and contemplated. The star may be oriented over the utility pole to help a user place the cap 11 correctly during assembly so that light bar is properly positioned.

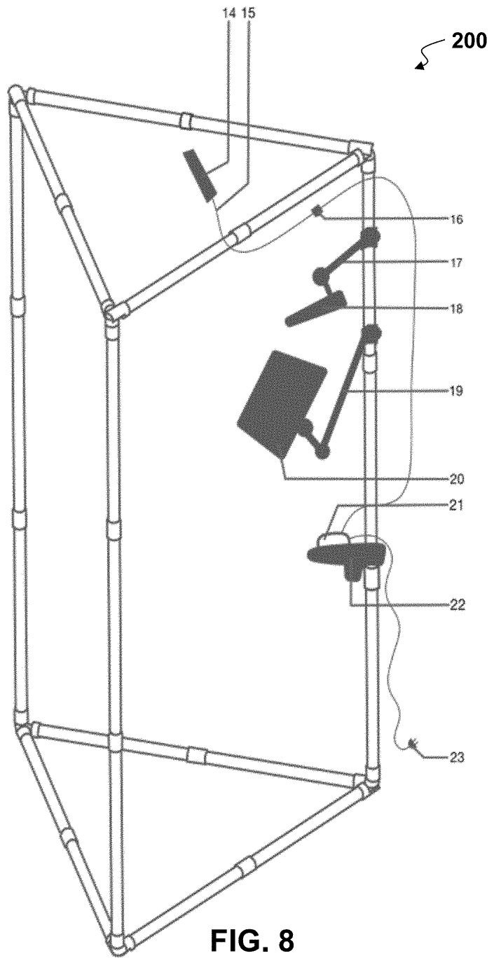

With respect to FIG. 8, the placement of accessories is shown on the apparatus 200. Accessories may include the light bar 14, a light bar power cord 15, a rotary dimmer knob 16, an adjustable microphone boom 17, a mount and microphone 18, an adjustable holder boom 19, a holder 20, a power hub 21, a tray 22, and an extension tray 23. The light bar 14 may be a 12 inch LED dimmable light bar with warm white glow. The light bar 14 may be bright enough for the user to, for example, read scripts and see clearly within the apparatus 200, while not straining the user's eyes. The light bar 14 may add no or minimal heat. The light bar power cord 15 may be long enough to reach the power hub 21 on the tray 2. The rotary dimmer knob 16 may control the brightness of the light bar 14 located within reach of the user. The adjustable microphone boom 17 may be black in color and may be adjusted to a height and angle desired by the user. The end of the boom 17 may have a universal male threaded bolt to receive a mount, such as mount 18. The mount and microphone may be supplied by a user and may be utilized in the apparatus 200 while traveling. The holder boom 19 may be an adjustable black copy lectern boom. The holder boom 19 maybe adjusted to a height and angle preferred by the user. The holder 20 may be a black copy lectern. The holder 20 may be a sturdy and reliable place for the user to place the user's paper scripts, tablet, or laptop from which to read, rather than having to hold them. The power hub 21 may provide three USB charge ports and one or more standard power outlets so the user may power the LED light bar, as well as to power and/or charge a laptop, tablet, cellphone, and the like. The tray 22 may be a beverage and utility tray. The tray 22 may be entirely adjustable to make it easily within reach of the user. The user now has a safe place to put any potentially noise-producing or delicate items the user may possess, such as coins, keys, jewelry, sunglasses, and the like. The tray 22 may also include a beverage receptacle to hold a beverage. The extension cord 23 may be a fifteen foot extension cord to ensure the power hub's 21 power cord may reach wall outlets in any given room, allowing the user more choice as to the best location for the apparatus 200 to ensure the quietest placement.

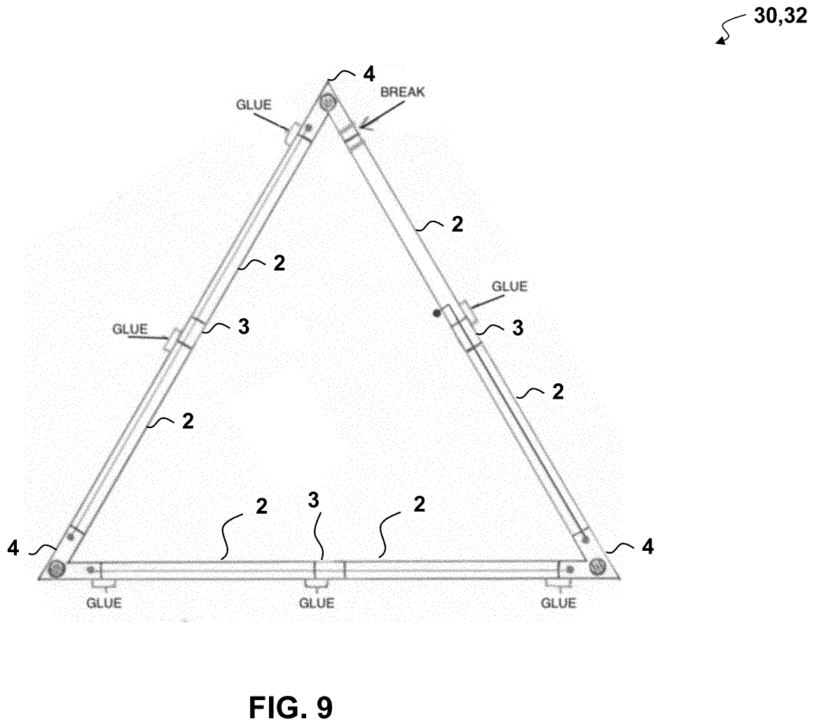

With respect to FIG. 9, the apparatus 100 may include a matching bottom frame 30 and top frame 32, which may be segmented. In one embodiment, each side of the frames 30,32 may be comprised of a segment 2. In one embodiment, segments 2 may be connected with a connector 10. In one embodiment, the ends of the segments 2 may be threaded for threading the segments 4 into threaded portions inside the connectors 3. In another embodiment, the opening diameter of the connectors 3 is slightly larger than the outer diameter of the ends of the segments 2 to allow for a push-fit of the segments 2 into the connectors 3. The ends of the segments 3 opposite the ends connected to the connectors 3 are connected to a joint 4. In one embodiment, the joints 4 are 3-way PVC connector joints. Two openings of each joint 4 are for receiving a segment 2. The segments 2 may be glued at the connectors 3 and the joints 4.

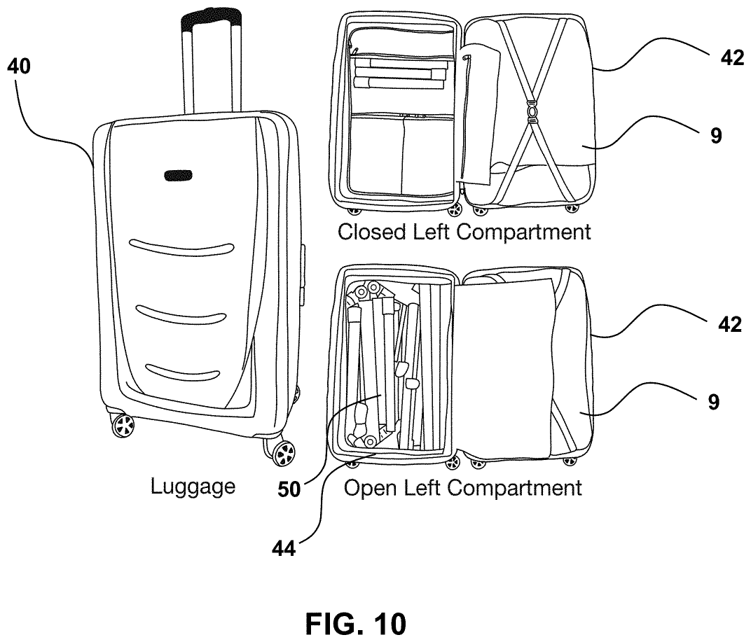

With respect to FIG. 10, the previously described apparatus 200 is shown disassembled and stowed in a 28 inch hard-shell supplied piece of luggage, such as a case allowing the performer to travel with their booth on all major means of transportation including air travel. The overall weight of luggage including all of its contents may be less than the 501b limit at airport check-in scales which if exceeded the traveler typically incurs a fee.

In one embodiment, the apparatus 100 may be collapsible and separable for easy transport in the case 40. For example, the case 40 is shown in an opened configuration, where the enclosure may be folded and fit into a first 42 compartment of the case 40. The frame 50 may be collapsed by separating the segments from the connectors and the joints, and fit within a second compartment 44 of the case 40. A panel may be used to separate the enclosure from the frame 50. In one embodiment, the frame 50 may collapse down to a height of less than 3.5 feet.

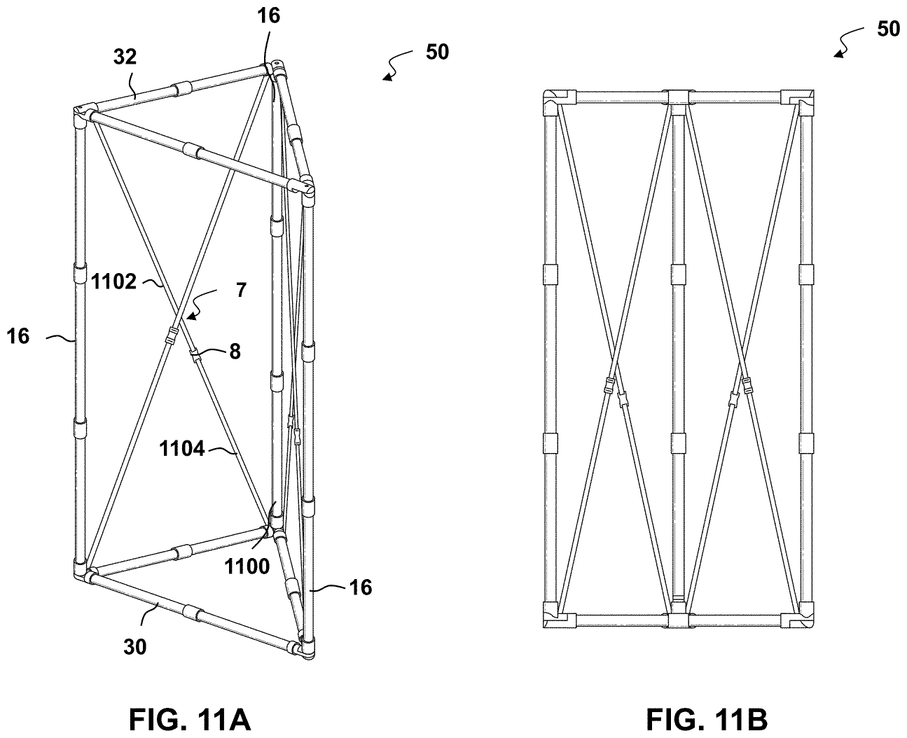

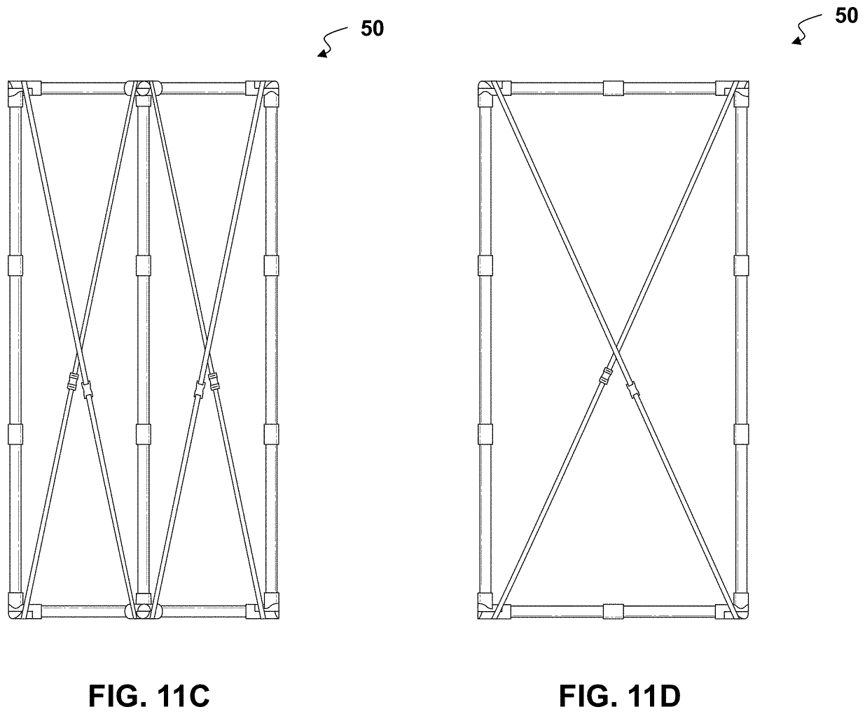

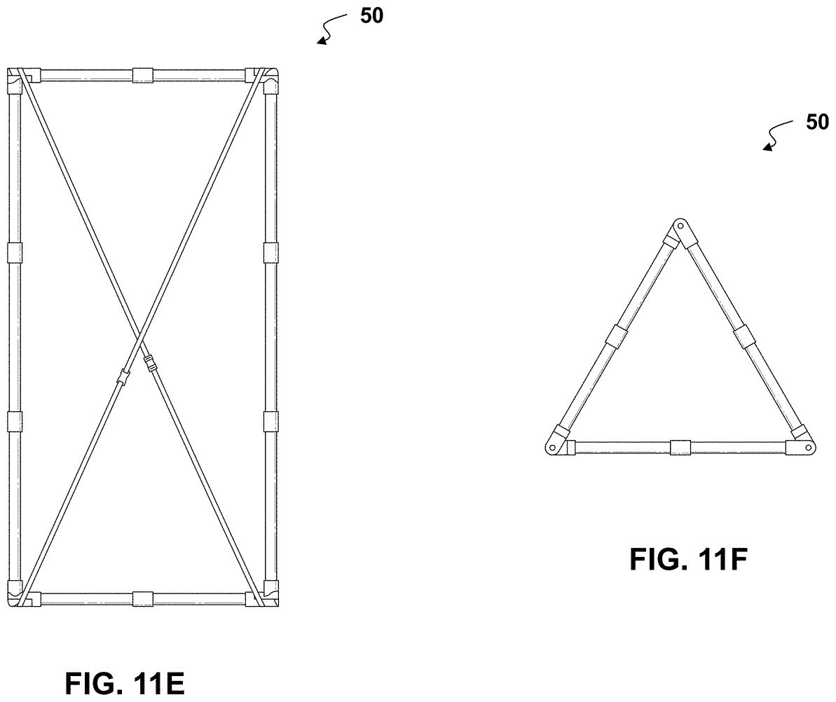

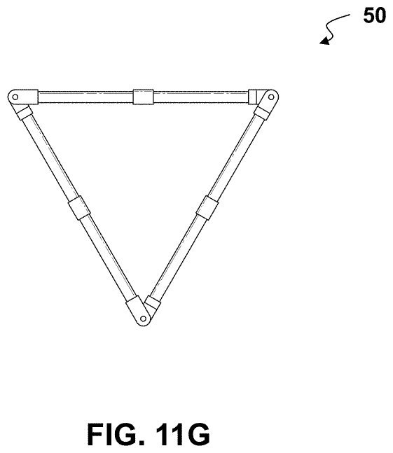

FIG. 11A is a perspective view of an embodiment of a portable vocal recording booth frame 50, according to one embodiment. The frame 50 includes three support legs 16. One of the three support legs 16 may be a utility pole 1100. The frame 50 may also include one or more support straps 7. Each support strap may be attached to the frame between an upper corner of the top triangular frame 32 and a lower opposite corner of the bottom triangular frame 30. Two of the one or more support straps 7 may form an X-shape. The one or more support straps 7 may be disposed on two sides of the frame 50, wherein the frame 50 has three sides. In some embodiments, each support strap 7 may include an upper strap 1102 and a lower strap 1104. The upper strap is detachably attached to the lower support strap by a connector 8. The connector 8 may be a side-release buckle in some embodiments. The connector 8 may allow for the support strap 7 to be lengthened or shortened. The connector 8 may allow for tightening of the support strap 7 so as to provide tension on the frame 50 to ensure that the frame is sturdy and secure.

FIG. 11B is a front elevational view of the embodiment of FIG. 11A. FIG. 11C is a rear elevational view of the embodiment of FIG. 11A. FIG. 11D is a right side elevational view of the embodiment of FIG. 11A. FIG. 11E is a left side elevational view of the embodiment of FIG. 11A. FIG. 11F is top plan view of the embodiment of FIG. 11A. FIG. 11G is a bottom plan view of the embodiment of FIG. 11A.

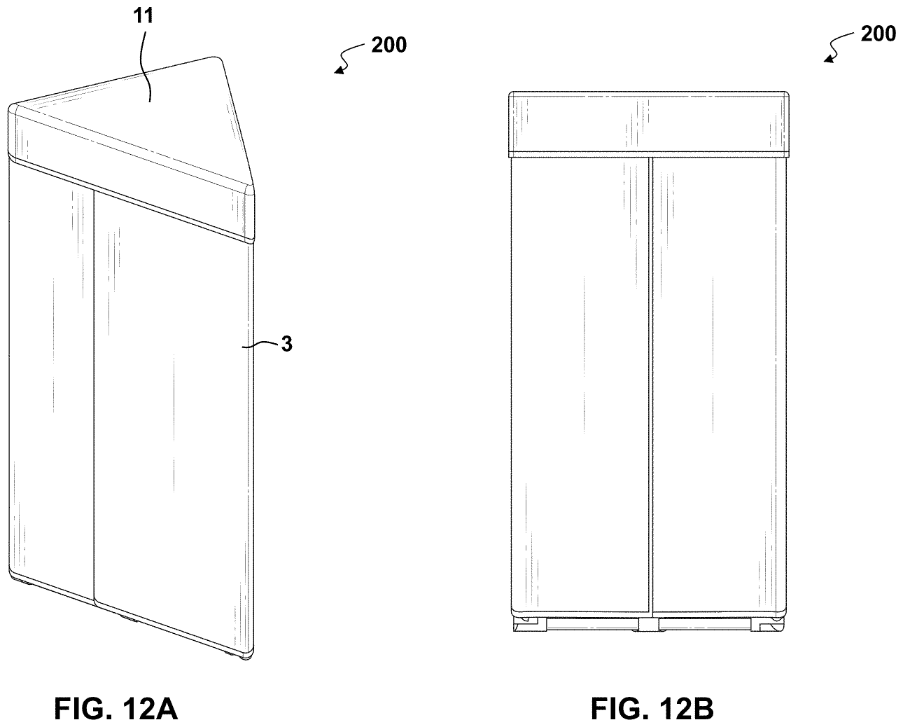

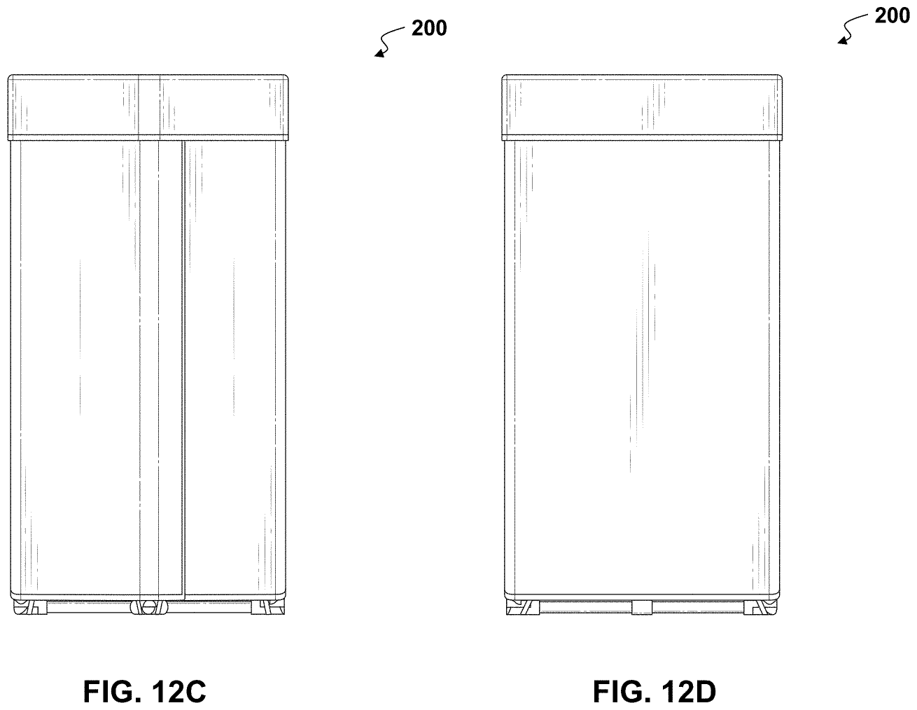

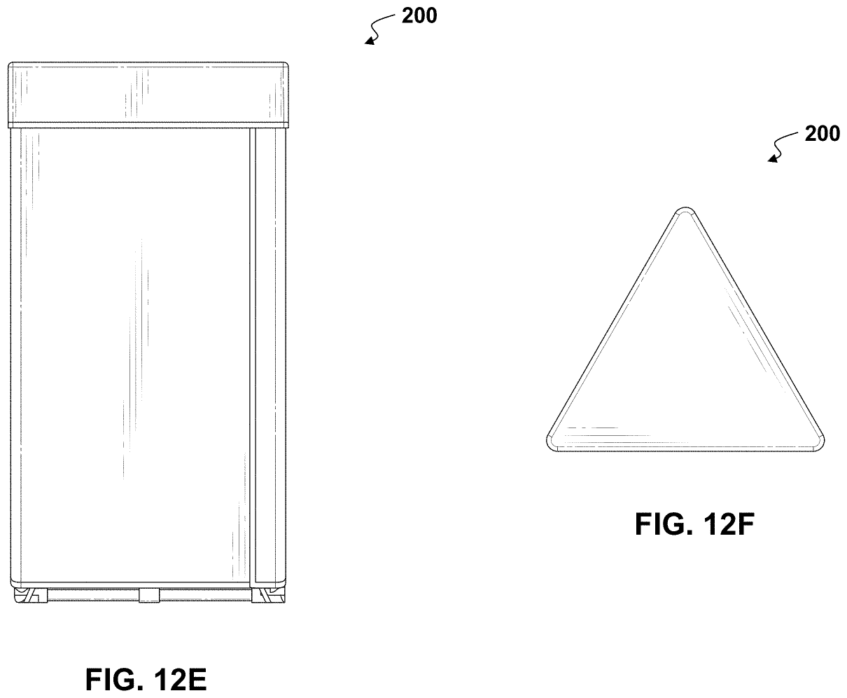

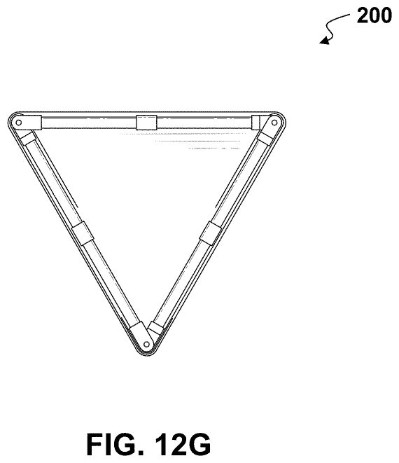

FIG. 12A is a perspective view of the portable vocal recording booth 200 having a cap 11 and acoustic paneling 3 covering the frame of FIG. 11A. The acoustic paneling 3 may enclose at least a portion of the frame of FIG. 11A. One side of the booth 200 may act as a door where the acoustic paneling 3 may be parted to allow a user to enter into the interior of the booth 200. FIG. 12B is a front elevational view of the embodiment of FIG. 12A. FIG. 12C is a rear elevational view of the embodiment of FIG. 12A. FIG. 12D is a right side elevational view of the embodiment of FIG. 12A. FIG. 12E is a left side elevational view of the embodiment of FIG. 12A. FIG. 12F is top plan view of the embodiment of FIG. 12A. FIG. 12G is a bottom plan view of the embodiment of FIG. 12A.

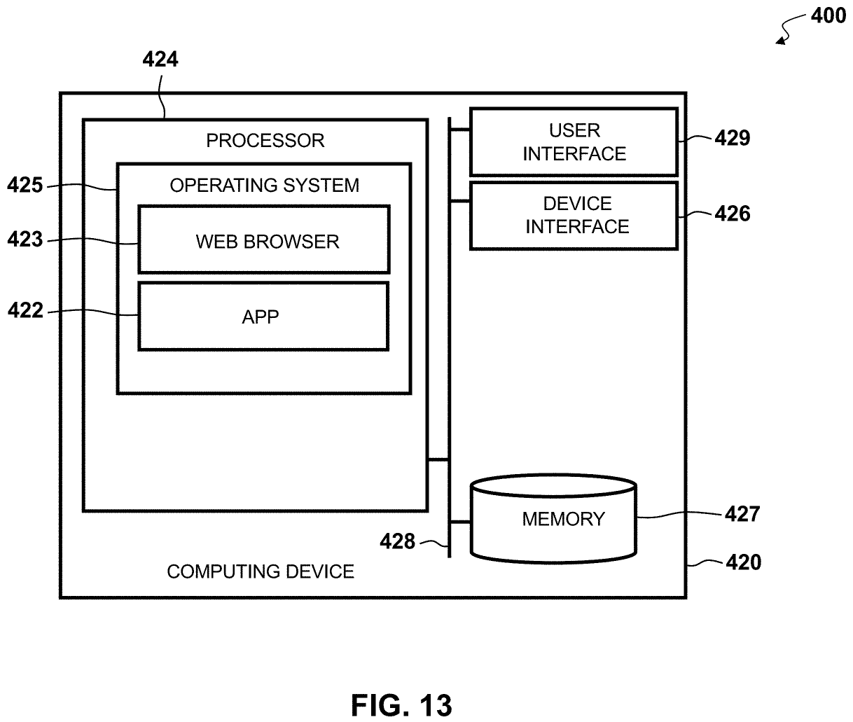

FIG. 13 illustrates an example of a top-level functional block diagram of a computing device embodiment 400. The example operating environment is shown as a computing device 420 (see FIG. 1) comprising a processor 424, such as a central processing unit (CPU), addressable memory 427, an external device interface 426, e.g., an optional universal serial bus port and related processing, and/or an Ethernet port and related processing, and an optional user interface 429, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 428. In some embodiments, via an operating system 425 such as one supporting a web browser 423 and applications 422, the processor 424 may be configured to execute steps of a process establishing a communication channel and processing according to the embodiments described above. In one embodiment, the computing device 420 may be a digital signal processing device for compare sample a user's recording from other acoustic recording environments in order to design acoustic correction parameters. In one embodiment, input received in the apparatus 100 at the computing device 420 may be processed with processor 424. The processor 420 may execute steps to run the application 422 for applying the design acoustic correction parameters. After this application, sounds made in the apparatus 100 are substantially indistinguishable from sounds made in the user's other acoustic recording environments.

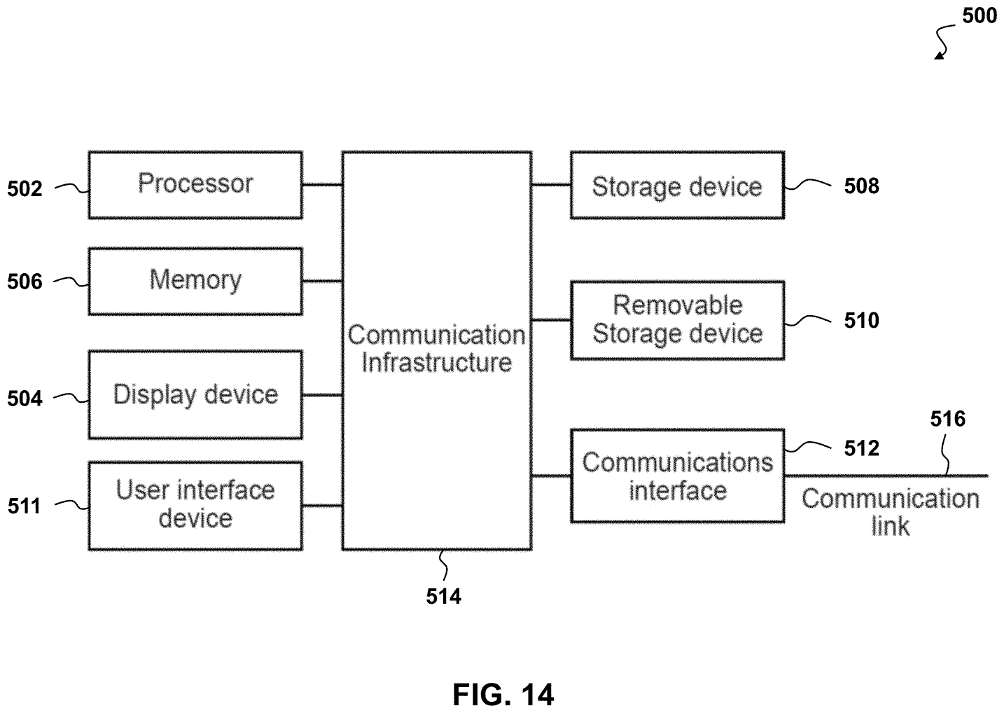

FIG. 14 is a high-level block diagram 500 showing a computing system comprising a computer system useful for implementing an embodiment of the system and process, disclosed herein. Embodiments of the system may be implemented in different computing environments. The computer system includes one or more processors 502, and can further include an electronic display device 504 (e.g., for displaying graphics, text, and other data), a main memory 506 (e.g., random access memory (RAM)), storage device 508, a removable storage device 510 (e.g., removable storage drive, a removable memory module, a magnetic tape drive, an optical disk drive, a computer readable medium having stored therein computer software and/or data), user interface device 511 (e.g., keyboard, touch screen, keypad, pointing device), and a communication interface 512 (e.g., modem, a network interface (such as an Ethernet card), a communications port, or a PCMCIA slot and card). The communication interface 512 allows software and data to be transferred between the computer system and external devices. The system further includes a communications infrastructure 514 (e.g., a communications bus, cross-over bar, or network) to which the aforementioned devices/modules are connected as shown.

Information transferred via communications interface 514 may be in the form of signals such as electronic, electromagnetic, optical, or other signals capable of being received by communications interface 514, via a communication link 516 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 512. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

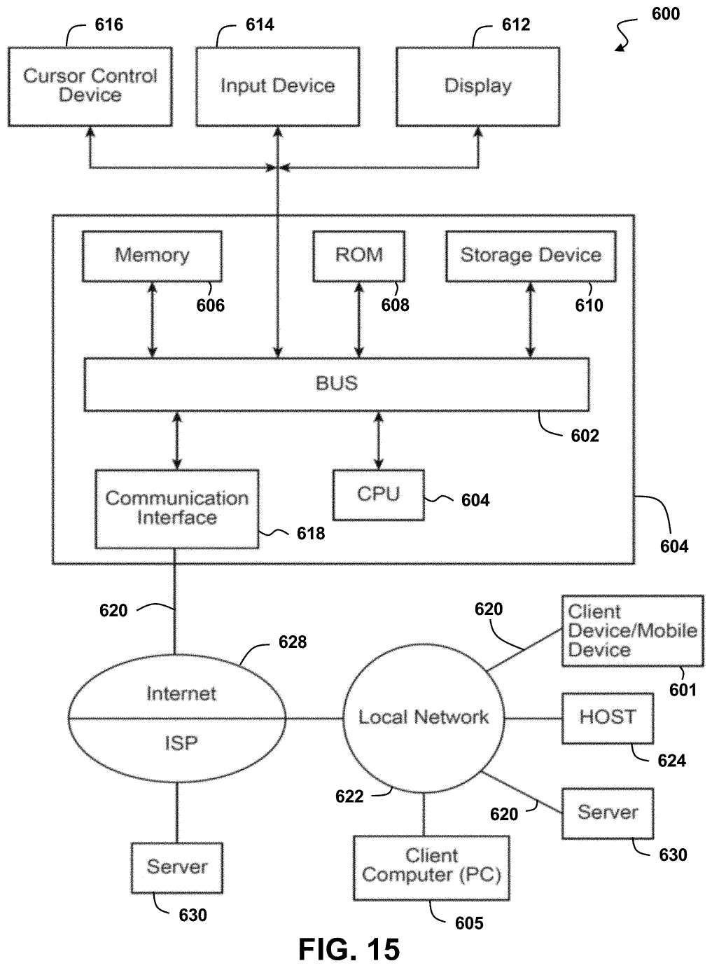

FIG. 15 shows a block diagram of an example system 600 in which an embodiment may be implemented. The system 600 includes one or more client devices 601 such as consumer electronics devices, connected to one or more server computing systems 630. A server 630 includes a bus 602 or other communication mechanism for communicating information, and a processor (CPU) 604 coupled with the bus 602 for processing information. The server 630 also includes a main memory 606, such as a random access memory (RAM) or other dynamic storage device, coupled to the bus 602 for storing information and instructions to be executed by the processor 604. The main memory 606 also may be used for storing temporary variables or other intermediate information during execution or instructions to be executed by the processor 604. The server computer system 630 further includes a read only memory (ROM) 608 or other static storage device coupled to the bus 602 for storing static information and instructions for the processor 604. A storage device 610, such as a magnetic disk or optical disk, is provided and coupled to the bus 602 for storing information and instructions. The bus 602 may contain, for example, thirty-two address lines for addressing video memory or main memory 606. The bus 602 can also include, for example, a 32-bit data bus for transferring data between and among the components, such as the CPU 604, the main memory 606, video memory and the storage 610. Alternatively, multiplex data/address lines may be used instead of separate data and address lines.

The server 630 may be coupled via the bus 602 to a display 612 for displaying information to a computer user. An input device 614, including alphanumeric and other keys, is coupled to the bus 602 for communicating information and command selections to the processor 604. Another type or user input device comprises cursor control 616, such as a mouse, a trackball, or cursor direction keys for communicating direction information and command selections to the processor 604 and for controlling cursor movement on the display 612.

According to one embodiment, the functions are performed by the processor 604 executing one or more sequences of one or more instructions contained in the main memory 606. Such instructions may be read into the main memory 606 from another computer-readable medium, such as the storage device 610. Execution of the sequences of instructions contained in the main memory 606 causes the processor 604 to perform the process steps described herein. One or more processors in a multi-processing arrangement may also be employed to execute the sequences of instructions contained in the main memory 606. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 604 for execution.

Such a medium may take many forms, including but not limited to, non-volatile media, volatile media, and transmission media. Non-volatile media includes, for example, optical or magnetic disks, such as the storage device 610. Volatile media includes dynamic memory, such as the main memory 606. Transmission media includes coaxial cables, copper wire and fiber optics, including the wires that comprise the bus 602. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 604 for execution. For example, the instructions may initially be carried on a magnetic disk of a remote computer. The remote computer can load the instructions into its dynamic memory and send the instructions over a telephone line using a modem. A modem local to the server 630 can receive the data on the telephone line and use an infrared transmitter to convert the data to an infrared signal. An infrared detector coupled to the bus 602 can receive the data carried in the infrared signal and place the data on the bus 602. The bus 602 carries the data to the main memory 606, from which the processor 604 retrieves and executes the instructions. The instructions received from the main memory 606 may optionally be stored on the storage device 610 either before or after execution by the processor 604.

The server 630 also includes a communication interface 618 coupled to the bus 602. The communication interface 618 provides a two-way data communication coupling to a network link 620 that is connected to the world wide packet data communication network now commonly referred to as the Internet 628. The Internet 628 uses electrical, electromagnetic or optical signals that carry digital data streams. The signals through the various networks and the signals on the network link 620 and through the communication interface 618, which carry the digital data to and from the server 630, are exemplary forms or carrier waves transporting the information.

In another embodiment of the server 630, interface 618 is connected to a network 622 via a communication link 620. For example, the communication interface 618 may be an integrated services digital network (ISDN) card or a modem to provide a data communication connection to a corresponding type of telephone line, which can comprise part of the network link 620. As another example, the communication interface 618 may be a local area network (LAN) card to provide a data communication connection to a compatible LAN. Wireless links may also be implemented. In any such implementation, the communication interface 618 sends and receives electrical electromagnetic or optical signals that carry digital data streams representing various types of information.

The network link 620 typically provides data communication through one or more networks to other data devices. For example, the network link 620 may provide a connection through the local network 622 to a host computer 624 or to data equipment operated by an Internet Service Provider (ISP). The ISP in turn provides data communication services through the Internet 628. The local network 622 and the Internet 628 both use electrical, electromagnetic or optical signals that carry digital data streams. The signals through the various networks and the signals on the network link 620 and through the communication interface 618, which carry the digital data to and from the server 630, are exemplary forms or carrier waves transporting the information.

The server 630 can send/receive messages and data, including e-mail, program code, through the network, the network link 620 and the communication interface 618. Further, the communication interface 618 can comprise a USB/Tuner and the network link 620 may be an antenna or cable for connecting the server 630 to a cable provider, satellite provider or other terrestrial transmission system for receiving messages, data and program code from another source.

The example versions of the embodiments described herein may be implemented as logical operations in a distributed processing system such as the system 600 including the servers 630. The logical operations of the embodiments may be implemented as a sequence of steps executing in the server 630, and as interconnected machine modules within the system 600. The implementation is a matter of choice and can depend on performance of the system 600 implementing the embodiments. As such, the logical operations constituting said example versions of the embodiments are referred to for e.g., as operations, steps or modules.

Similar to a server 630 described above, a client device 601 can include a processor, memory, storage device, display, input device and communication interface (e.g., e-mail interface) for connecting the client device to the Internet 628, the ISP, or LAN 622, for communication with the servers 630.

The system 600 can further include computers (e.g., personal computers, computing nodes) 605 operating in the same manner as client devices 601, where a user can utilize one or more computers 605 to manage data in the server 630.

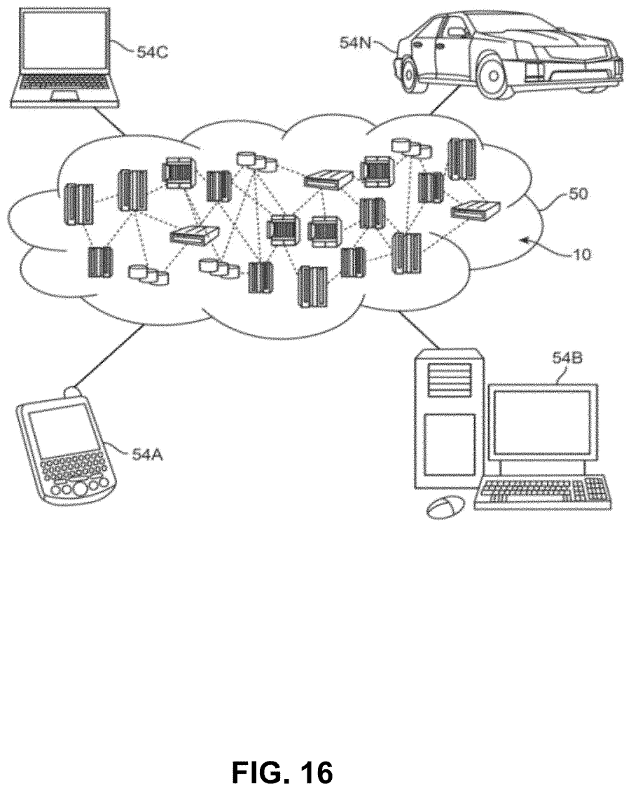

Referring now to FIG. 16, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 13 are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A portable voice recording apparatus comprising:
a frame, wherein the frame comprises:
a top triangular frame;
a bottom triangular frame; and
one or more support legs connecting the top triangular frame to the bottom triangular frame;
an acoustic paneling attached to the frame, wherein the acoustic paneling encloses at least a portion of the frame, wherein the acoustic paneling provides an interior of the apparatus, and wherein the interior of the apparatus reduces noise and echo as compared to an exterior of the apparatus.

2. The apparatus of claim 1, wherein the frame is collapsible.

3. The apparatus of claim 1, wherein the frame further comprises:
one or more support straps.

4. The apparatus of claim 1, wherein each support strap of the one or more support straps is attached to the frame between an upper corner of the top triangular frame and a lower opposite corner of the bottom triangular frame.

5. The apparatus of claim 4, wherein two of the one or more support straps form an X-shape.

6. The apparatus of claim 4, wherein the one or more support straps are disposed on two sides of the apparatus, wherein the apparatus has three sides.

7. The apparatus of claim 4, wherein each support strap comprises an upper strap and a lower strap.

8. The apparatus of claim 7, wherein the upper strap is detachably attached to the lower support strap by a connector.

9. The apparatus of claim 8, wherein the connector is a side-release buckle.

10. The apparatus of claim 1, further comprising:
a cap, wherein the cap covers the top triangular frame.

11. The apparatus of claim 10, wherein the cap comprises a quilted cotton pad.

12. The apparatus of claim 1, wherein the acoustic paneling comprises quilted cotton pads.

13. The apparatus of claim 1, further comprising:
one or more internal elastics, wherein the one or more internal elastics are disposed in at least one of: the top triangular frame, the bottom triangular frame, and the one or more support legs.

14. The apparatus of claim 13, wherein the one or more internal elastics are disposed in the top triangular frame, the bottom triangular frame, and the one or more support legs, and wherein each of the one or more internal elastics connect the frame when the frame is disassembled.

15. The apparatus of claim 13, wherein the one or more internal elastic comprise a bungee cord.

16. The apparatus of claim 1, wherein the one or more support legs comprise three legs, and wherein one of the three support legs comprises a utility pole, wherein the Utility Pole comprises one or more mounts and a power hub.

17. The system of claim 16, further comprising:
a light bar disposed proximate the top triangular frame, wherein the light bar is connected to the power hub by a light bar power cable;
a dimmer knob connected to the light bar power cable, wherein the dimmer knob is configured to adjust a light output of the light bar;
one or more microphones attached to one or more mounts; and
one or more trays attached to the one or more mounts.

18. A method comprising:
connecting one or more first poles via one or more external couplings to form a first support leg of three support legs;
connecting one or more first poles via one or more external couplings to form a second support leg of three support legs;
connecting one or more first poles via one or more external couplings to form a third support leg of three support legs, wherein the third support leg comprises a utility pole, and wherein the utility pole comprises one or more mounts and a power hub;
connecting one or more second poles via one or more external couplings and one or more three-way angled couplings to form a top triangular frame;
connecting one or more second poles via one or more external couplings and one or more three-way angled couplings to form a bottom triangular frame;
connecting each of the three support legs to the top triangular frame and the bottom triangular frame via the one or more three-way angled couplings, wherein the three support legs, the top triangular frame, and the bottom triangular frame form a frame;
connecting one or more support straps between an upper corner of the top triangular frame and a lower opposite corner of the bottom triangular frame, wherein two of the one or more support straps form an X-shape, and wherein the one or more support straps are disposed on two sides of the frame, wherein the frame has three sides; and
connecting an acoustic paneling to the frame, wherein the acoustic paneling encloses at least a portion of the frame, wherein the acoustic paneling provides an interior of the apparatus, and wherein the interior of the apparatus reduces noise and echo as compared to an exterior of the apparatus.

19. The method of claim 18, further comprising:
detaching the acoustic paneling from the frame;
detaching the one or more support straps from the frame;
disconnecting each of the three support legs from the top triangular frame and the bottom triangular frame;
disconnecting the one or more second poles of the bottom triangular frame;
disconnecting the one or more second poles of the top triangular frame;
disconnecting the one or more first poles from each of the three support legs; and
storing the disconnected top triangular frame, bottom triangular frame, three support legs and acoustic paneling in a case for storage and transport.

20. An apparatus for voice recording comprising:
a collapsible structure;
a first wall of sound-absorbing material coupled to the collapsible structure;
a second wall of sound-absorbing material angled less than ninety degrees relative to the first wall of sound-absorbing material and coupled to the collapsible structure; and
a microphone support disposed between the first and second walls of sound-absorbing material and coupled to the collapsible structure.
